(19) United States
(12) Patent Application Publication
(10) Pub. No.: US 2006/0271514 A1
(43) Pub. Date: Nov. 30, 2006

(54) Structure of customized web services

(75) Inventors: Zechary Chang, Taipei (TW); Sam Sha, Beijing (CN); Pinky Ma, Beijing (CN)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/117,140

(22) Filed: Apr. 27, 2005

(51) Int. Cl. G06F 17/30; G06F 7/00

(52) U.S. Cl. 707/3

(57) ABSTRACT

A structure of customized web services includes a document format related to web services, a description document of provided services, and definitions of operation and communication methods. The customized web services structure contains: a services searching exhibitor, which is built upon a basic program code to provide the standards for registration in the basic program code structure and searching the web services; a services provider, which uses the web services defined by the basic program code structure and shows the contents in the services searching exhibitor for searching; and a services requester, which makes use of the basic program code structure. The basic program code is one of the non-XML type Vc, Vb or C# programming codes of high compatibility.

### BACKGROUND OF THE INVENTION

1. Field of Invention

The invention relates to a web services structure and, in particular, to a structure of customized web services.

2. Related Art

The web service is a kind of software that provides services to other application programs using a web communication protocol and an open standard of data format (e.g. HTTP, XML, and SOAP). The use of the open standard gives the web services high compatibility. Systems built upon different programming languages on different platforms can be readily integrated. The web service can be used to build systems with distributive structures to implement their advantages of dynamical integration, balanced loads, and unit upgrade.

In practice, suppose one wants to build a travel website, which provides travel information, reservation of air ticket and hotel, weather information. It is only necessary to find the web services objects of these services and integrate them in the website. The user does not need to spend time and resources to maintain the database of travel and weather information and to build mechanisms for hotel and air ticket reservation and payment.

FIG. 1 shows the basic structure of conventional web services. It mainly includes a services requester 1, a services provider 3, and universal description discovery and integration (UDDI) 5. Moreover, the web services description language (WSDL) is used to describe how web services operate and tells the services requester 1 how to have interactions with the system. The simple object access protocol (SOAP) us a simple communication protocol based upon extensible mark-up language (XML) for exchanging structurized and categorized information in a distributive environment on the network. The XML is a basic language. We briefly describe in the following paragraphs the basic structure and operation scheme.

The UDDI 5 provides a standard for registration and searching the web services. When the services provider 3 announces the provided services to the public, he or she has to register at the UDDI 5. On the other hand, when a services requester 1 or user needs to use the services, he or she inquires the UDDI 5 whether any services provider provides the required services. The services requester 1 or user further obtains information related to binding with the services (a WSDL description) to interact directly with the services provider 3.

When a services provider 3 wants to announce the provided web services, he or she has to use the WSDL to write description files that describe the web services and allowed operations in the web services. Such descriptions include how a services requester 1 operate and communicate with the web services, including the information of the communication protocol, format, and parameters.

The SOAP is used in a distributive network environment for data exchanges using the standard transmission protocols such as HTTP, SMTP, and TCP on the Internet. A communication can be established as long as both parties support the SOAP. In other words, the SOAP simply packs the request message of the services requester 1 and the response message of the services provider 3 in the XML format for both parties to communicate.

Using the above-mentioned structure and standard, the services requester 1 can use a program written using any language, employing any element model, and executing on any operating system to access the web services provided by the services provider 3. The flexibility of using the XML format enables flexible message exchanges.

Since the web services use an open standard, systems built upon different programming languages on different platforms can be readily integrated. The ASP.NET web page structures or NET Framework program codes used to establish the web services have high compatibility. Thus, the user 1 needs to have a better processing efficiency; otherwise, such a high compatibility may cause a burden for the user. From another perspective, the high compatibility only increases the load of the system for some particular users.

### SUMMARY OF THE INVENTION

In view of the foregoing, an objective of the invention is to use the techniques of web services to provide a simplified web services structure, which utilizes program codes of the basic structure to replace that based on ASP.NET or NET Framework according to the requests of different customers. Although the web services thus formed does not have a high compatibility, the processing efficiency of the customer's system can be increased. Therefore, the invention relies less on the customer's system efficiency.

In other words, the point of the invention is to define a new web services structure using a different basic structure program code according to the customer's needs. Such a customized structure can effectively reduce the load of the customer's system.

To achieve the above objectives, the disclosed structure of customized web services contains a document format related to web services, a description document of provided services, and definitions of operation and communication methods. The customized web services structure contains: a services searching exhibitor, which is built upon a basic program code to provide the standards for registration in the basic program code structure and searching the web services; a services provider, which uses the web services defined by the basic program code structure and shows the contents in the services searching exhibitor for searching; and a services requester, which makes use of the basic program code structure to send a searching service request to the services searching exhibitor, uses the data format defined in the basic program code to ask the services provider for a content description of the web services when receiving a response from the services searching exhibitor, and sends out a service request to the service provider after receiving the content description.

The above-mentioned basic program code structure can be the Vc.net, Vb.net or C#.net structure.

Moreover, the content description of the web services that the services provide responds to the services requester can be binary data. After the services requester receives the web services content description, he or she returns with a web service content description defined in the basic program code. The web service is then provided after the services requester's request is received.

### BRIEF DESCRIPTION OF THE DRAWINGS

The invention will become more fully understood from the detailed description given hereinbelow illustration only, and thus are not limitative of the present invention, and wherein:

FIG. 1 is a basic structure of conventional web services;

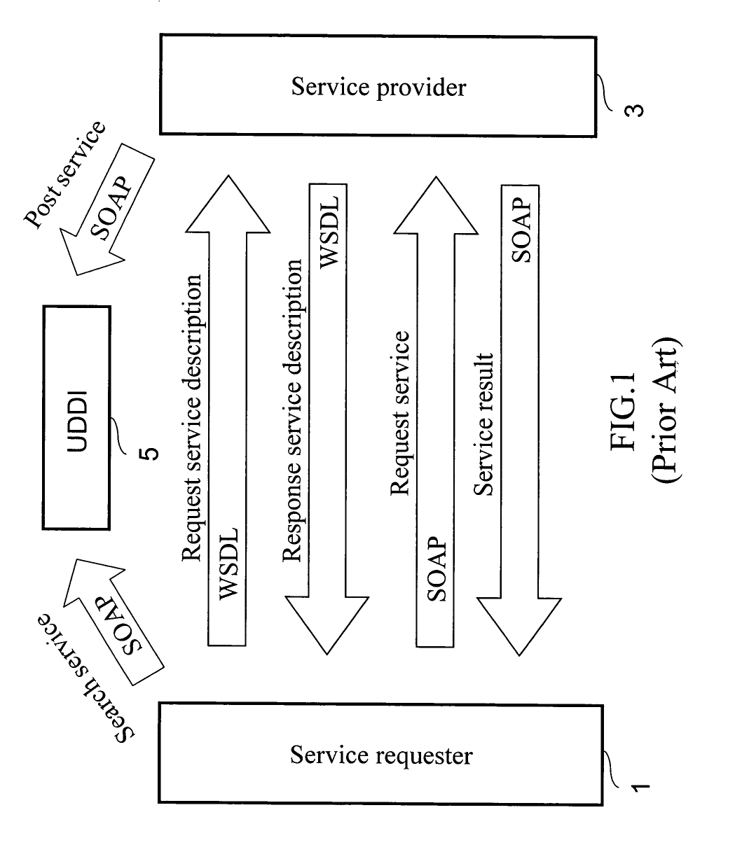

FIG. 2 is a basic structure of disclosed customized web services;

FIG. 3 is a schematic view of the kit for developing conventional web services; and

FIG. 4 is a schematic view of the kit for developing the customized web services according to the invention.

### DETAILED DESCRIPTION OF THE INVENTION

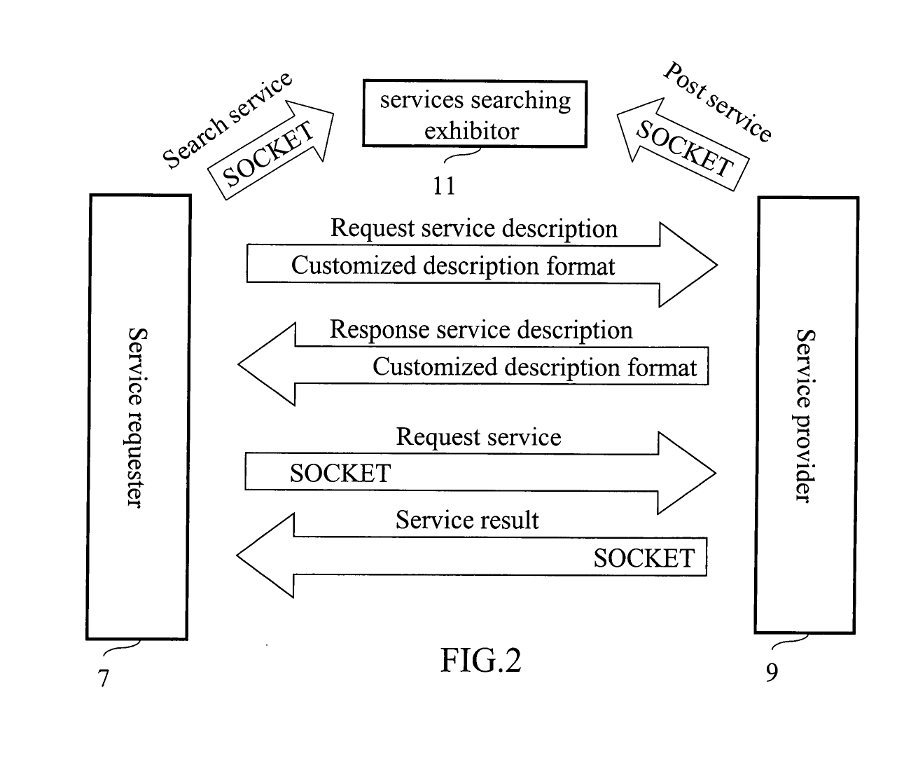

FIG. 2 shows a basic structure of the customized web services according to the invention. It mainly includes a services requester 7, a services provider 9, and a services searching exhibitor 11. The invention is characterized in that a basic program code structure replaces the use of the ASP.NET or NET Framework to build the services requester 7, the services provider 9, and the services searching exhibitor 11 along with the provided contents.

In particular, the invention does not use a web services description language (WSDL) as the operation means of describing a web service. According to the client3 s request, the invention defines the customized document format for exchanging web services, the description document of provided services, and possible interaction means between the services requester 7 and the web services according to a customized description format generated by the basic program code structure.

Using a low-level SOCKET network transmission method along with a standard network communication protocol, it is not necessary to define an extensible mark-up language (XML)-based simple object access protocol (SOAP) for web services as in the prior art. According to the customer's request, the invention uses the basic program code language to replace the XML for writing the web services.

The basic program code can be Vc, Vb, or C#, and the structure can be Vc.net, Vb.net, or C#.net.

In the following, we describe the basic structure and the operation of the invention.

The services searching exhibitor 11 uses a basic program code structure to provide the standards for registration and searching web services under the disclosed structure. When the services provider 9 wants to announce provided services to the public, he or she has to register at this mediator 11. On the other hand, when the services requester 7 or a user needs the services, he or she only needs to inquire at the mediator 11 whether any one provides the required service (i.e. making a request). Once the services requester obtains information about binding with the services (in a customized description format), he or she can interact with the services provider 9 directly.

The invention is characterized in that the services searching exhibitor 11 and the customized description format use the basic program code structure to replace the ASP.NET or .NET Framework structure.

The services provider 9 provides the web services defined using the basic program code structure and displays the contents on the services searching exhibitor for the user to search. After the services provider receives a request for the web service content description, a response of the web service content description is provided. Once the services requester sends out a request for one web service, the services provider provides the web service.

The services requester 7 uses the basic program code structure to send out a services searching request to the services searching exhibitor, presenting requests for a web service content description and getting a web service to the services provider. After receiving the response from the services searching exhibitor, the services requester can use the data format defined by the basic program code to send out a request for the web service content description from the services provider. After receiving the content description, the services requester can ask for a web service from the services provider.

The invention is characterized in that: the request for a web service content description or the response of the services provider 9 to the web service content description of the services requester 7 are written in the customized basic program code. It can be binary data. Therefore, it can be transmitted using the SOCKET along with existing network communication protocol, rendering a faster transmission rate.

Since the service content is written using the customized basic program code, the response is transmitted in binary data via the SOCKET along with existing network communication protocol, without the need of any extra network protocol. For the same reason, the service content does not contain the character of the compatibility with other languages, its execution at the services requester 7 will not bring too much burden to the system.

In summary, the services requester 7 uses the SOCKET along with existing network communication protocol to connect with the services searching exhibitor 11 for searching the required services. On the other hand, the services provider 9 also uses the SOCKET along with existing network communication protocol to connect with the services searching exhibitor 11 for posting provided services and their links.

Moreover, the data format transmitted between the services requester 7 and the services provider 9 is written in the basic program code. They can be binary data that are transmitted via the SOCKET along with existing network communication protocol. Therefore, the transmission rate is faster.

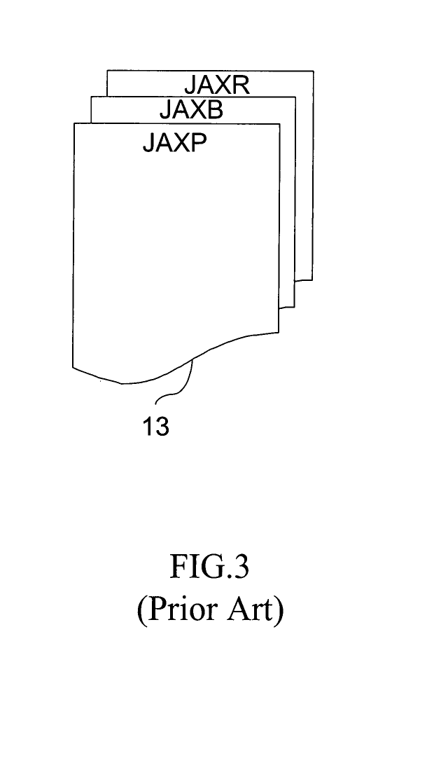

FIG. 3 shows the kit for developing conventional web services. As shown in the drawing, the WSDP kit 13 for developing web services contains JAXP, JAXB, JAXR, JAX-RPC, etc. It can be used to establish web services application programs and the proxy class that the customer or user needs to access web services. The above-mentioned kits all support the XML format. Therefore, the user or customer does not need to have a developing structure with high compatibility. A developing kit with high compatibility will only increase the burden of the system.

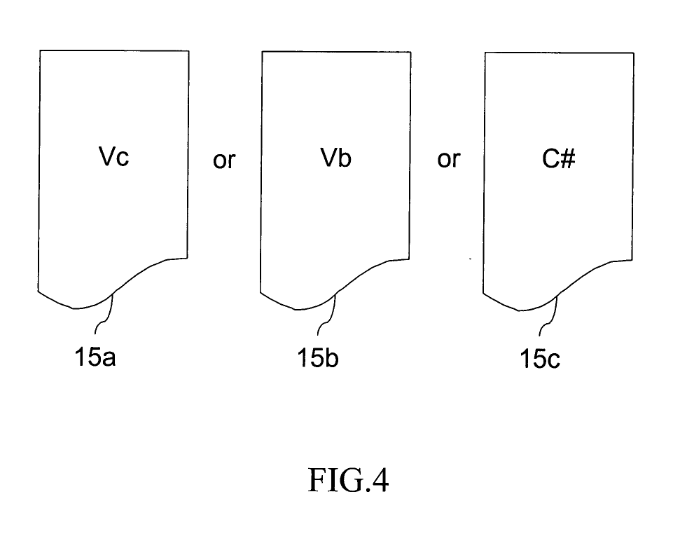

FIG. 4 shows the disclosed kit for developing customized web services. As described before, the basic concept of the invention is to design a customized web services structure without supporting the XML format. It is defined using existing programming languages such as Vc, Vb, or C# according to the customer's request. Therefore, the web services developing kit does not use the WSDP kit, but use a structure such as Vc.net 15a, Vb.net 15b, or C#.net 15c. Thus, the developed content is smaller than that developed based upon the XML. It further has the advantages of fast transmissions via the SOCKET and imposing no burden to the system.

To summarize, the invention uses the basic program code structure to replace the ASP.NET or NET Framework for writing the web services structures. The customized web service structures thus established are designed for individual customers and have smaller contents than developed using XML. Therefore, the processing efficiency on the customer's system is increased. It is thus more suitable for small-platform customers.

In other words, the invention indeed can use different basic program structures to redefine the web service structures according to the customer's request. The customized structure can effectively reduce the burden of the customer's system.

Certain variations would be apparent to those skilled in the art, which variations are considered within the spirit and scope of the claimed invention.

What is claimed is:

1. A customized web services structure containing a document format related to web services, a description document of provided services, and definitions of operation and communication methods, the customized web services structure comprising:
a services searching exhibitor, which uses a basic program code structure to provide a standard for registration and searching the web services;
a services provider, which provides the web services defined using the basic program code structure and displays the content on the services searching exhibitor for searching; and
a services requester, which uses the basic program code structure to send out a searching service request to the services searching exhibitor, uses the data format defined by the basic program code to ask the services provider for the web service content description after receiving a response from the service searching exhibitor, and sends out a web service request to the services provider after receiving the content description.

2. The customized web services structure of claim 1, wherein the basic program code structure is a Vc.net structure.

3. The customized web services structure of claim 1, wherein the basic program code structure is a Vb.net structure.

4. The customized web services structure of claim 1, wherein the basic program code structure is a C#.net structure.

5. The customized web services structure of claim 1, wherein the web service content description responded by the services provider to the services requester is in binary data.

6. The customized web services structure of claim 1, wherein the services provider responds the services requester with the web service content description defined in the basic program code structure after receiving his/her request.

7. The customized web services structure of claim 1, wherein the services provider provides the web services after receiving the web service request sent out by the services requester.

8. The customized web services structure of claim 7, wherein the web service is defined by the basic program code structure.
